(19) United States
(12) Patent Application Publication
(10) Pub. No.: US 2013/0057381 A1
(43) Pub. Date: Mar. 7, 2013

(54) THERMOSTAT AND METHOD

(71) Applicant: Senthilkumar Mettuppalayam Kandhasamy, Bangalore (IN)

(72) Inventor: Senthilkumar Mettuppalayam Kandhasamy, Bangalore (IN)

(73) Assignee: HONEYWELL INTERNATIONAL INC., Morristown, NJ (US)

(21) Appl. No.: 13/226,340

(22) Filed: Sep. 6, 2011

(51) Int. Cl. H01H 37/70

(52) U.S. Cl. 337/348

(57) ABSTRACT

The present disclosure relates to thermostats. In one illustrative embodiment, a thermostat includes a housing defining a cavity, an electrical contact, a temperature sensitive disc that is configured to transition from a first stable state to a second stable state at a first temperature, and a spring disc having a first stable state and a second stable state. During operation, the temperature sensitive disc may apply a force to the spring disc that causes the spring disc to transition from its first stable state to its second stable state when the temperature sensitive disc transition from its first stable state to its second stable state at the first temperature. The force required to move the spring disk from the first stable state to the second stable state may be less than the force required to move the spring disk from the second stable state to the first stable state.

### TECHNICAL FIELD

The disclosure relates generally to thermostats.

### BACKGROUND

Thermostats are often used to control and/or monitor equipment such as HVAC equipment, water heaters, manufacturing equipment, as well as other equipment. Some thermostat, such as double disc thermostats, may include a thermally responsive bimetallic disc in combination with a spring disc. The bimetal disc may exhibit a snap-action response to an external stimulus, such as temperature. The snap-action response may be used to actuate other components in the thermostat, such as a contact switch. In some instances, the bimetal disc may snap from a first stable to state to a second stable state upon reaching a set temperature. The spring disc may maintain the contact switch in the switched state, even after the temperature of the bimetal disc retreats to below the set temperature, thereby allowing the bimetal disc to return to its first stable state. It has been found that the reliability of some double disc thermostats is reduced because the force that is required from the bimetal disk to snap the spring disk from its first stable position to its second stable position is larger than desired.

### SUMMARY

The present disclosure relates generally to thermostats. In one illustrative embodiment, a thermostat includes a housing defining a cavity, an electrical contact, and a temperature sensitive disc that is configured to transition from a first stable state to a second stable state at a first temperature. The illustrative thermostat also includes a spring disc positioned adjacent to the temperature sensitive disc. The spring disc may have a first stable state and a second stable state. During operation, the temperature sensitive disc may apply a force to the spring disc that causes the spring disc to transition from its first stable state to its second stable state when the temperature sensitive disc transition from its first stable state to its second stable state at the first temperature. During this transition, the spring disc and/or the temperature sensitive disc may cause the electrical contact to move between an open state and a closed state. In some instances, the force required to move the spring disk from the first stable state to the second stable state may be less than the force required to move the spring disk from the second stable state to the first stable state.

The preceding summary is provided to facilitate an understanding of some of the innovative features unique to the present disclosure, and is not intended to be a full description. A full appreciation of the disclosure can be gained by taking the entire specification, claims, drawings, and abstract as a whole.

### BRIEF DESCRIPTION OF THE DRAWINGS

FIG. 1 is a schematic cross-section of an illustrative double disc thermostat with a contact in a closed position;

FIG. 2 is a schematic cross-section of the illustrative double disc thermostat of FIG. 1 with the contact in an open position;

FIG. 3 is a schematic cross-section of the illustrative double disc thermostat of FIG. 1 with the contact in the open position after a temperature sensitive disc of the double disc thermostat has returned to a first stable state;

FIG. 4A is a schematic cross-section of an illustrative spring disc in a first stable state;

FIG. 4B is a schematic cross-section of the illustrative spring disc of FIG. 4A in a second stable state; and

FIG. 5 is a schematic cross-section of the illustrative spring disc of FIG. 4B assembled with an illustrative temperature sensitive disc.

While the disclosure is amenable to various modifications and alternative forms, specifics thereof have been shown by way of example in the drawings and will be described in detail. It should be understood, however, that the intention is not to limit aspects of the disclosure to the particular embodiments described. On the contrary, the intention is to cover all modifications, equivalents, and alternatives falling within the spirit and scope of the disclosure.

### DESCRIPTION

For the following defined terms, these definitions shall be applied, unless a different definition is given in the claims or elsewhere in this specification.

All numeric values are herein assumed to be modified by the term “about”, whether or not explicitly indicated. The term “about” generally refers to a range of numbers that one of skill in the art would consider equivalent to the recited value (i.e., having the same function or result). In many instances, the term “about” may be indicative as including numbers that are rounded to the nearest significant figure.

The recitation of numerical ranges by endpoints includes all numbers within that range (e.g., 1 to 5 includes 1, 1.5, 2, 2.75, 3, 3.80, 4, and 5).

Although some suitable dimensions ranges and/or values pertaining to various components, features and/or specifications are disclosed, one of skill in the art, incited by the present disclosure, would understand desired dimensions, ranges and/or values may deviate from those expressly disclosed.

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The following description should be read with reference to the drawings in which similar elements in different drawings are numbered the same. The description and the drawings, which are not necessarily to scale, depict illustrative embodiments and are not intended to limit the scope of the disclosure. The illustrative embodiments depicted are intended only as exemplary. Selected features of any illustrative embodiment may be incorporated into an additional embodiment unless clearly stated to the contrary.

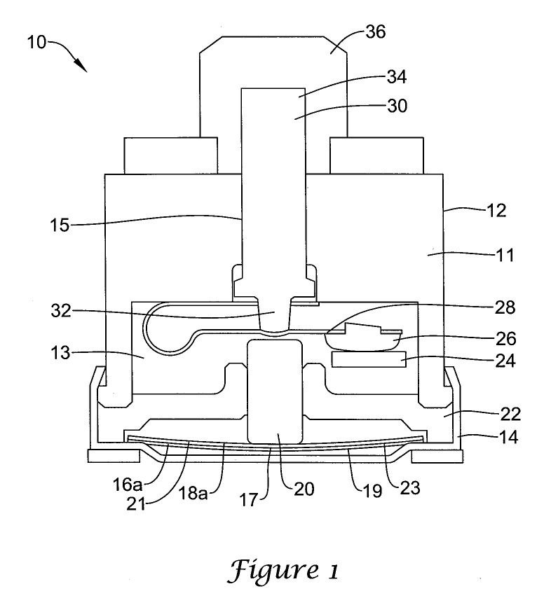

FIG. 1 is a schematic cross-section of an illustrative double-disc thermostat 10 with the electrical contacts 24, 26 in a closed position. The illustrative thermostat 10 includes a base 12 and a cap 14 which may collectively form a housing for receiving the components of the thermostat 10. In some instances, the base 12 may include a substantially solid portion 11 and a substantially hollow portion or cavity 13. The substantially solid portion 11 may include a passage or through-hole 15 for receiving a reset pin 30. In some embodiments, the cap 14 may be a generally hollow piece configured to mate with the base 12 and generally enclose the cavity 13. While this is one example construction, it is contemplated that the housing may be formed in any manner as desired.

In the illustrative embodiment, the reset pin 30 may extend from a first end 32 within the cavity 13 through the passage 15 to a second end 34 outside of the base 12. In some embodiments, the reset pin 30 may include an enlarged push button 36 adjacent to the second end 34, although this is not required. The first end 32 of the reset pin 30 may be connected to a moving electrical contact 26. In some instances, the reset pin 30 may not be directly connected to the moving electrical contact 26. For example, in some embodiments, it is contemplated that the reset pin 30 may be attached or to or engages a wire or spring 28, or other connecting means, which in turn is connected to the moving electrical contact 26. In some embodiments, the reset pin 30 may be directly connected to the moving electrical contact 26. The moving electrical contact 26 may be configured to come into contact with a fixed electrical contact 24 under a first set of operating conditions to complete an electrical circuit. Under a second set of operating conditions, the moving electrical contact 26 may be configured to move away from the fixed contact 24 such that the electrical circuit is broken.

The illustrative thermostat 10 may, in some cases, include a temperature sensitive element 16a,b configured to actuate a transfer pin 20 at a set temperature. In some embodiments, the temperature sensitive element 16a,b may include a bimetallic disc having a generally conical shape. The word “disc” as used herein may include generally round outer shapes, generally square outer shapes, generally rectangular outer shapes, generally triangular outer shapes, or any other suitable shape, as desired. In some cases, the bimetal disc may include a first metal and a second metal, wherein the first metal has a different coefficient of thermal expansion than that the second metal.

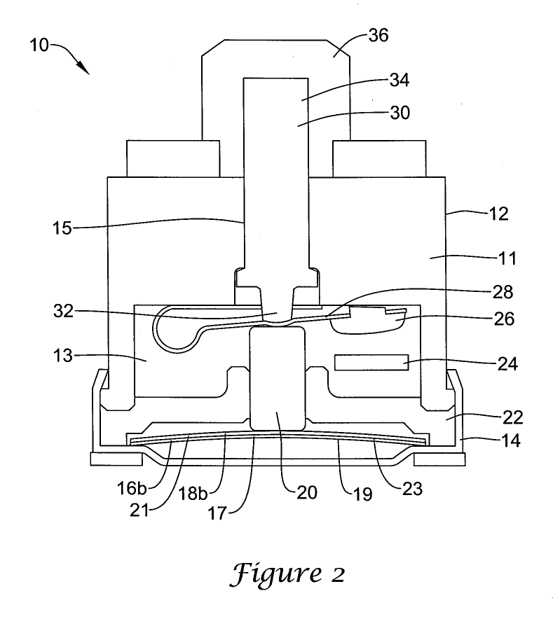

The bimetal disc 16a,b may exhibit a snap-action response to an external stimulus, such as a temperature change. The snap-action response may be used to actuate other components in the thermostat 10, such as transfer pin 20. In some instances, the bimetal disc 16a,b may have a first stable state 16a (see FIG. 1) and a second stable state 16b (see FIG. 2). In the first stable state 16a, the bimetal disc 16a,b may have a first side 17 having a generally concave shape and a second side 19 having a generally convex shape, as shown in FIG. 1. In some cases, a non-temperature sensitive spring disc 18a,b having a generally conical shape may be provided in addition to the bimetal disc 16a,b. In some instances, the spring disc 18a,b may have a first stable state 18a (see FIG. 1) and a second stable state 18b (see FIG. 2). In the first stable state 18a, the spring disc 18 may have a first side 21 having a generally concave shape and a second side 23 having a generally convex shape, as shown in FIG. 1.

In some embodiments, the spring disc 18a,b may be assembled with the bimetal disc 16 such that the second side 23 of the spring disc 18 faces the first side 17 of the bimetal disc 16. While the bimetal discs 16a,b, 18a,b may be assembled side by side, it is contemplated that the discs 16a,b, 18a,b may not be fixedly secured to one another such that the bimetal disc 16a,b and the spring disc 18a,b may move independently of one another. In some embodiments, a disc retainer 22 may be provided to secure the bimetal disc 16a,b and the spring disc 18a,b within the housing. In some instances, when the spring disc 18 is in its first stable state 18a (see FIG. 1), the electrical contacts 24, 26 may be in a closed state, as shown in FIG. 1. In other embodiments, when the spring disc 18 is in its first stable state 18a (see FIG. 1), the electrical contacts 24, 26 may be in an open state (not shown).

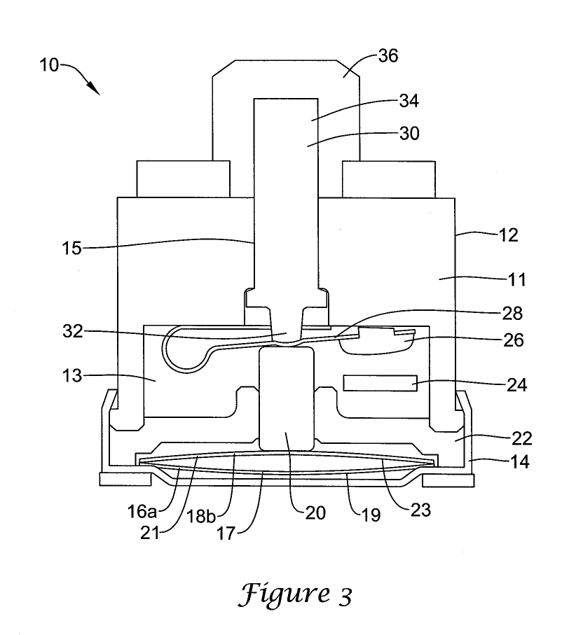

Referring now to FIG. 2, the bimetal disc 16a,b may have a second stable state 16b, and the spring disc 18 may have a second stable state 18b. The bimetal disc 16a,b may move from the first stable state 16a to the second stable state 16b when the temperature of the bimetal disc 16a,b crosses a set temperature. At the set temperature, the bimetal disc 16 a,b may spontaneously transition, or snap, from the first stable state 16a (see FIG. 1) to the second stable state 16b (see FIG. 2). When in the second stable state 16b, the first side 17 of the bimetal disc 16a,b may have a generally convex shape while the second side 19 may be generally concave as shown in FIG. 2. The snap-action of the bimetal disc 16a,b moving from the first stable state 16a to the second stable state 16b may move the spring disc 18a,b from its first stable state 18a to its second stable state 18b. When in the second stable state 18b, the first side 21 of the spring disc 18a,b may have a generally convex shape while the second side 23 may be generally concave as shown in FIGS. 2 and 3. When the spring disc 18a,b moves from the first stable state 18a to the second stable state 18b, the spring disc 18 may push the transfer pin 20 in an upwards direction (see FIGS. 1 and 2). As will be discussed in more detail below, in some embodiments, the bimetal disc 16 may move from the second stable state 16b to the first stable state 16a when, for example, the temperature falls below the set temperature (see FIG. 3).

In some embodiments, the force of the transfer pin 20 moving in the upwards direction may force the reset pin 30 to move in an upwards direction. As the transfer pin 20 moves upwards, and in the illustrative embodiment, the moving electrical contact 26 may become separated from a fixed contact 24, thus opening the circuit (see FIG. 2). In some instances, it may be desirable to maintain the circuit in the open position, even after the temperature has cooled below the set temperature and, in some cases, the bimetal disc 16a,b has returned to its first stable state 16a, as shown in FIG. 3. In some embodiments, it may be desirable for the electrical contacts 24, 26 to remain open, unless manually closed (such as at temperatures greater than −20° Celsius). Thus, and in some instances, it may be desirable for the spring disc 18a,b to remain in the second stable state 18b until an external force, such as a user manually depressing the push button 36 (and hence the reset pin 30), acts on the spring disc 18a,b to return the spring disc 18a,b to the first stable state 18a from the second stable state 18b.

FIG. 3 is a schematic cross-section of an illustrative double-disc thermostat 10 with the electrical contacts 24, 26 in the open position after the temperature sensitive disc 16a,b of the double disc thermostat has returned to its first stable state. As indicated above, and in some instances, the bimetal disc 16a,b may return to its first stable state 16a after the temperature cools below a set temperature (which may be the same or different from the set temperature that the bimetal disc 16a,b moved from the first stable state 16a to the second stable state 16b). In some applications, it may be desirable for the electrical contacts 24, 26 to remain open once bimetal disc 16a,b has snapped and opened the electrical contacts 24, 26. In such applications, the spring disc 18a,b may remain in its second stable state 18b until an external force acts upon it, thus maintaining the electrical contacts 24, 26 in the open position even if the bimetal disc 16a,b returns to its first stable state 16a. In some instances, a manual external force may be required to return the spring disc 18a,b (and/or temperature sensitive disc 16a,b) to its first stable state. In some instances, a user may be required to depress a push button, such as push button 36, to force a reset pin 30 downwards. In the illustrative embodiment, as the reset pin 30 is moved downwards, the moving electrical contact 26 is brought into contact with the fixed contact 24. The reset pin 30 also exerts a downward force on the transfer pin 20. The transfer pin 20 may exert a sufficient force on the first side 21 of the spring disc 18a,b to return the spring disc 18a,b (and/or temperature sensitive disc 16a,b) to its first stable state 18a (see FIG. 1).

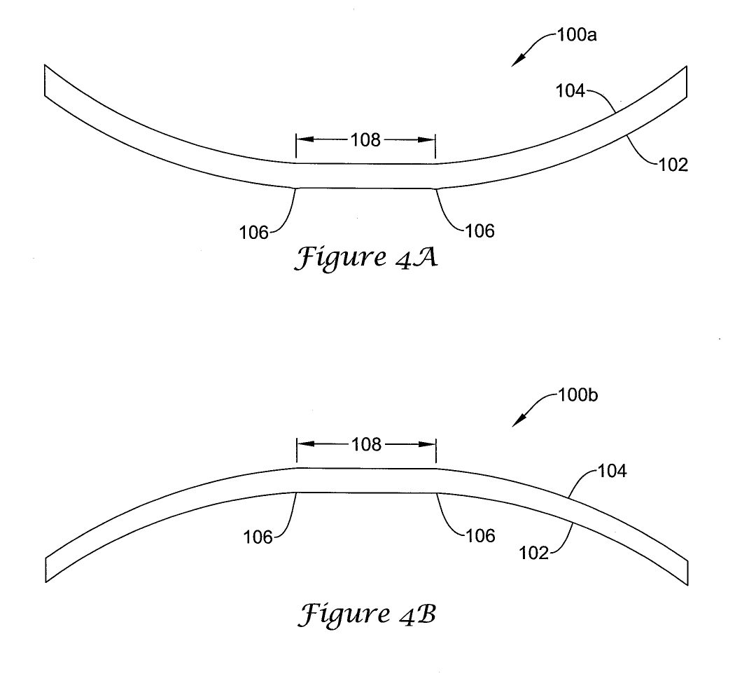

FIG. 4A is a cross-section of an illustrative spring disc 100a after forming. In some cases, the spring disc 100a may be used in a double-disc thermostat, similar to that shown and described above with respect to FIGS. 1-3. In some instances, the spring disc 100a may be air formed using a punch and die. When so formed, a generally round flat disc may be placed in a die having an open profile. A punch having a generally flat region surrounded by a generally cup shaped region may be brought into contact with the flat disc thus forming the spring disc 100a. The flat disc may be of any suitable material, such as, but not limited to, stainless steel. The flat disc may have any diameter (or other dimension) as desired, such as, but not limited to, 5.0-15.0 mm. This range, however, is merely exemplary. The flat disc may have any size desired for the application at hand, and the punch and die may be appropriately scaled.

The punch and die forming operation may create a flat portion 108 on a first side 104 (the side formed by the punch) of the spring disc 100a. At the edges of the flat portion 108, a relatively sharp crease or angle may be formed as the spring disc 100a transitions from the flat region to the curved portion. The second side 102 (the side formed by the die) of the spring disc 100a may have two radii 106 formed during the manufacturing process. While not explicitly shown, in some embodiments, the forming radius 106 may be larger than the thickness of the disc material. The curvature of the spring disc 100a may begin at the radii 106. Stress points may occur at the starting points of the curvature. For example, stress points may occur at the edges of the flat portion 108 and at the radii 106.

The relatively sharp transition (smaller radii) from the flat portion 108 to the curved portion on the first side 104 may restrict snapping of the spring disc 100a from its formed state, or first stable state (see FIG. 4A), to a second stable state (see FIG. 4B). However, the relatively sharp transition on the first side 104 may require less force to snap the spring disc 100a,b from the second stable state 100b to the first stable state 100a. Thus, and in some instances, the spring disc 100a,b may require more force to move from its manufactured or formed state (the first stable state) 100a (see FIG. 4A) to the second stable state 100b (see FIG. 4B) than to move from the second stable state 100b (see FIG. 4B) to the first stable state (see FIG. 4A). For example, it may require approximately 25% more force to move from the manufactured or formed state 100a to the second stable state 100b. If the spring disc 100a,b is assembled into the thermostat 10 of FIG. 1 with the manufactured or formed state as the first stable state (e.g. such that the second side 102 of the spring disc 100a is adjacent to the bimetal disc 16a,b), the spring disc 100a,b may require more force to flip to the second stable state 18b (as described above) than to be manually reset the spring disc 100a,b from the second stable state 18b to the first stable state 18a. In some instances, this may cause the bimetal disc 16a,b to prematurely fail due to fatigue. However, it is contemplated that if one were to manually snap the spring disc 100a,b prior to assembling it within the thermostat (as shown in FIG. 4B), the force required to snap the spring disc 18a,b from the first stable state 18a (e.g. now state 100b of FIG. 4B) to the second stable state 18b (e.g. now state 100a of FIG. 4A) may be less than the force required if the spring disc 18a,b is assembled in its manufactured or formed state. In some cases, this may extend the life of the of the bimetal disc 16a,b by reducing the amount of force it must exert on the spring disc 18a,b to open (or close in some embodiments) the electrical contacts 24,26. In some instances, the bimetal disc 16a,b may exhibit an improved performance when the spring disc 100a,b is snapped prior to assembling it within the thermostat. For example, the bimetal disc 16a,b may experience an improved response (e.g. quicker and/or more consistent) to an external stimulus, such as a temperature change

In addition to extending the life of the bimetal disc 16a,b, it is contemplated that snapping the spring disc 100a,b prior to assembling it within the thermostat, may also improve the performance of the spring disc 100a,b. For example, in some instances, after many cycles (e.g. opening and closing) of the electrical contacts 24,26, the spring disc 100a,b may become relaxed allowing the bimetal disc 16a,b to drive the spring disc 100a,b in two directions (e.g. from the first stable state to the second stable state and from the second stable to the first stable state). The increased force required to move the spring disc 100a,b from the second stable state to the first stable state may help prevent the bimetal disc 16a,b from driving the spring disc 100a,b from the second stable state to the first stable state.

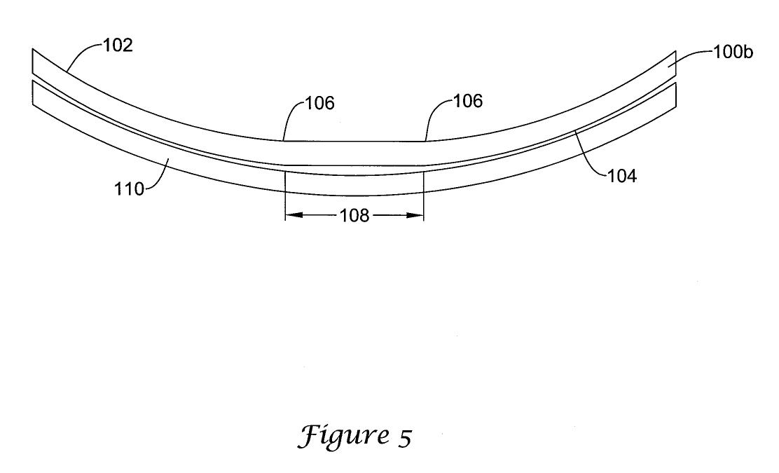

FIG. 5 illustrates a spring disc 100b assembled with a bimetal disc 110 in the manner described above with respect to FIGS. 4A and 4B. The spring disc 100b may be positioned such that the first side 104 is adjacent to the bimetal disc. As discussed above, the relatively sharp transition on the first side 104 from the flat portion 108 to the curved portion may require less force to snap the spring disc 100b to open the electrical contacts 24, 26 of FIG. 1. Further, the spring disc 100b may require a greater force to return the spring disc 100b to its original orientation. Also, this may help prevent the spring disc 100b from returning to its original orientation if/when the bimetal disc 110 has returned to its original orientation after the temperature has dropped below the set temperature.

Those skilled in the art will recognize that the present disclosure may be manifested in a variety of forms other than the specific embodiments described and contemplated herein. Accordingly, departure in form and detail may be made without departing from the scope and spirit of the present disclosure as described in the appended claims.

What is claimed is:

1. A thermostat comprising:
a housing defining a cavity;
an electrical contact;
a temperature sensitive disc that is configured to transition from a first stable state to a second stable state at a first temperature;
a spring disc positioned adjacent to the temperature sensitive disc, the spring disc having a first stable state and a second stable state, wherein the temperature sensitive disc applies a force to the spring disc that causes the spring disc to transition from its first stable state to its second stable state when the temperature sensitive disc transition from its first stable state to its second stable state at the first temperature;
the spring disc causes the electrical contact to move between an open state and a closed state when the spring disc transitions between its first stable state and the second stable state; and
wherein a force required to move the spring disk from the first stable state to the second stable state is less than a force required to move the spring disk from the second stable state to the first stable state.

2. The thermostat of claim 1 further comprising:
a reset pin for manually applying a force to transition the spring disc from its second stable state to its first stable state.

3. The thermostat of claim 2, wherein the force that causes the spring disc to transition from its first stable state to its second stable state also moves the reset pin.

4. The thermostat of claim 1 further comprising:
a transfer pin disposed between the spring disc and the electrical contact for transferring movement of the spring disc to the electrical contact.

5. The thermostat of claim 1, wherein the temperature sensitive disc includes a bimetal disc that includes a first metal and a second metal, wherein the first metal has a different coefficient of thermal expansion that the second metal.

6. The thermostat of claim 1, wherein when the temperature sensitive disc and the spring disc are in their first stable states, the electrical contact is in a closed position.

7. The thermostat of claim 6, wherein when the spring disc is in its second stable state, the electrical contact is in an open position.

8. The thermostat of claim 1, wherein when the temperature sensitive disc and the spring disc are in their first stable states, the electrical contact is in an open position.

9. The thermostat of claim 8, wherein when the spring disc is in its second stable state, the electrical contact is in a closed position.

10. A thermostat comprising:
a housing defining a cavity;
an electrical contact;
a temperature sensitive disc that is configured to transition from a first stable state to a second stable state at a first temperature;
a spring disc positioned adjacent to the temperature sensitive disc, the spring disc have a first stable state and a second stable state, wherein the temperature sensitive disc applies a force to the spring disc that causes the spring disc to transition from its first stable state to its second stable state when the temperature sensitive disc transition from its first stable state to its second stable state at the first temperature;
the spring disc causes the electrical contact to move between an open state and a closed state when the spring disc transitions between its first stable state and the second stable state;
the spring disc having a relatively flat central region surrounded by a curved portion; and
the spring disc having a first side facing the temperature sensitive disc and a second side facing away from the temperature sensitive disc, wherein a transition between the relatively flat region and the curved portion on the first side of the spring disk is sharper than a transition between the relatively flat region and the curved portion on the second side of the spring disk.

11. The thermostat of claim 10, wherein a force required to move the spring disk from the first stable state to the second stable state is less than a force required to move the spring disk from the second stable state to the first stable state

12. The thermostat of claim 10 further comprising:
a reset pin for manually applying a force to transition the spring disc from its second stable state to its first stable state.

13. The thermostat of claim 12, wherein the force that causes the spring disc to transition from its first stable state to its second stable state also moves the reset pin.

14. The thermostat of claim 10, wherein the temperature sensitive disc includes a bimetal disc that includes a first metal and a second metal, wherein the first metal has a different coefficient of thermal expansion that the second metal.

15. The thermostat of claim 10, wherein when the temperature sensitive disc and the spring disc are in their first stable states, the electrical contact is in a closed position.

16. The thermostat of claim 15, wherein when the spring disc is in its second stable state, the electrical contact is in an open position.

17. A method of assembling a thermostat, the method comprising:
providing a housing
providing a spring disc having a first stable state and a second stable state;
providing a bimetallic disc having a first stable state and a second stable state;
snapping the spring disc from the first stable state to the second stable state; and
installing the spring disc, in the second stable state, adjacent to the bimetallic disc in the housing of the thermostat.

18. The method of claim 17, wherein a force required to transition the spring disc from the first stable state to the second stable state is larger than the force required to move the spring disk from the second stable state to the first stable state.

19. The method of claim 17, wherein when in the first stable state, a first side of the spring disc has a concave shape and a second side of the spring disc has a convex shape.

20. The method of claim 19, wherein when in the second stable state, the second side of the spring disc has a concave shape and the first side of the spring disc has a convex shape.
